(19) United States
(12) Patent Application Publication
(10) Pub. No.: US 2025/0022084 A1
(43) Pub. Date: Jan. 16, 2025

(54) ETHISTORIAL ART: A METHOD FOR INTEGRATING HISTORICAL EVENTS, NFT-BASED ARTWORKS, AND COLLATERALIZATION IN THE CREATION AND MONETIZATION OF ARTISTIC EXPRESSIONS

(71) Applicants: Meesue Kim, Kirkland, WA (US); Yoo Seung Kim, Bangkok (TH); Nam Soo Kim, Incheon (KR); Min Kyu Kim, Incheon (KR)

(72) Inventors: Meesue Kim, Kirkland, WA (US); Yoo Seung Kim, Bangkok (TH); Nam Soo Kim, Incheon (KR); Min Kyu Kim, Incheon (KR)

(73) Assignee: Meesue Kim, Woodinville, WA (US)

(21) Appl. No.: 18/349,956

(22) Filed: Jul. 11, 2023

(51) Int. Cl. G06Q 50/18

(52) U.S. Cl. CPC G06Q 50/184

(57) ABSTRACT

Ethistorial Art presents a method combining historical events, NFT-based artwork, and collateralization to revolutionize artistic creation and monetization. By transforming historical incidents into art via blockchain technology, specifically Non-Fungible Tokens (NFTs), it links virtual and physical realms. Utilizing advanced technologies like electrical discharge machining (EDM) ensures exceptional craftsmanship and enhances the artworks' market appeal. Amalgamating NFTs with physical artifacts enables their collateralization, thus enhancing the NFTs' financial value. The method offers both artistic and practical collateral value, benefiting art collectors and enthusiasts. Intellectual property protection mechanisms secure the artworks' historical and artistic value, providing legal recognition for creators and owners. By promoting public interaction with these NFT-based artworks through performances and events, Ethistorial Art encourages cultural understanding and dialogue. By fusing history, culture, artistic expression, and technology, Ethistorial Art offers a new standard in the contemporary art market, providing abundant artistic and financial opportunities for artists, collectors, and investors.

### FIELDS

The present invention operates at the intersection of contemporary arts and technology, encompassing the following fields:

1. Contemporary Arts: The invention introduces a novel method for creating artworks within the genre of Ethistorial Art. This field encompasses various artistic expressions, including but not limited to digital art, paintings, sculptures, installations, and performances. The invention redefines the boundaries of contemporary arts by merging historical narratives, cultural heritage, and artistic expression, fostering creativity, and offering transformative experiences for artists, collectors, and audiences.

2. Technology: The invention incorporates advanced technologies such as blockchain and non-fungible tokens (NFTs) to provide a secure and transparent platform for the creation, monetization, and authentication of artworks. The utilization of high-end technologies like electrical discharge machining (EDM) enhances the precision, quality, and artistic value of the physical objects associated with the NFT-based artworks.

3. Intellectual Property Protection: The invention addresses the critical aspect of intellectual property protection within the realm of Ethistorial Art. It involves the registration and protection of NFT-based artworks and their associated intellectual property rights. This field ensures the legal recognition, authenticity, and commercial viability of the creations, fostering an environment conducive to artistic innovation, preservation, and fair economic practices.

4. Finance and Collateralization: The invention explores the practical applications of the artworks' financial value through collateralization. The field encompasses the assessment, appraisal, and leveraging of the intrinsic worth of the physical artifacts associated with the NFT-based artworks. By collateralizing these artifacts, the invention opens doors to financial arrangements such as loans or investments, providing art collectors with additional financial opportunities.

Overall, the invention operates in the realm where contemporary arts, technology, intellectual property protection, and finance converge, presenting a comprehensive and innovative approach to the creation, monetization, and collateralization of historical events within the Ethistorial Art genre.

### BACKGROUND OF THE INVENTION

The present invention introduces a comprehensive and innovative method for creating, monetizing, and collateralizing historical events through the genre of Ethistorial Art. This method merges historical narratives, NFT-based artworks, physical objects, and advanced technologies to offer a transformative approach to contemporary art.

By converting historical incidents and events into captivating artworks, the invention reinterprets and reimagines historical narratives. The integration of NFTs enables secure and transparent representation of these artworks in the virtual realm, while high-end technologies such as electrical discharge machining (EDM) enhance their aesthetic appeal and quality.

The invention creates a tangible link between the virtual and physical aspects of the artworks by incorporating NFTs with tangible artifacts, including symbolic jewelry and other physical objects. These artifacts serve as connections to the historical events and narratives represented in the NFT-based artworks and can be collateralized due to their intrinsic value.

To protect the historical and artistic value, the invention incorporates intellectual property protection mechanisms, ensuring legal recognition and authenticity. Additionally, the invention promotes public engagement through artistic performances, events, and exhibitions, fostering a deeper appreciation for history and cultural significance.

In summary, the present invention revolutionizes the contemporary art market by providing a comprehensive method for creating, monetizing, and collateralizing historical events through NFT-based artworks and advanced technologies within the Ethistorial Art genre.

### BRIEF SUMMARY OF THE INVENTION

The present invention introduces Ethistorial Art, a groundbreaking method that combines historical events, NFT-based artworks, and collateralization to revolutionize the contemporary art landscape. By converting historical incidents into captivating artworks represented by NFTs, the invention creates a new genre that bridges the virtual and physical realms. The integration of advanced technologies, including blockchain and electrical discharge machining (EDM), ensures the authenticity, precision, and bankability of the artworks. Physical artifacts associated with the NFTs further enhance their aesthetic and financial value. The invention also addresses intellectual property protection and offers opportunities for collateralization, opening doors for financial arrangements. Through immersive experiences and public engagement, the invention fosters appreciation for history and cultural significance. Overall, the Ethistorial Art method presents a transformative approach, combining art, technology, and finance, to create, monetize, and collateralize historical events in the contemporary art market.

### DESCRIPTION OF THE INVENTION

The present invention introduces a comprehensive and innovative method for creating, monetizing, and collateralizing historical events through the genre of Ethistorial Art. This method merges historical narratives, NFT-based artworks, physical objects, and advanced technologies to offer a transformative approach to contemporary art. The invention begins by converting historical incidents and events into captivating artworks that encapsulate their essence. These artworks serve as dynamic representations of the past, reinterpreting and reimagining historical narratives in thought-provoking ways. The integration of decentralized blockchain technology, specifically Non-Fungible Tokens (NFTs), allows for the secure and transparent representation of these artworks in the virtual realm. In order to enhance the artistic and financial value of the Ethistorial Artworks, the invention employs high-end technologies such as electrical discharge machining (EDM). This technology ensures precision accuracy and exceptional quality, elevating the aesthetic appeal and bankability of the artworks. By incorporating EDM, the invention adds a unique layer of craftsmanship and desirability to the physical artifacts associated with the NFT-based artworks. The integration of NFTs with tangible artifacts, including symbolic jewelry and other physical objects, creates a tangible link between the virtual and physical aspects of the artworks. These artifacts serve as tangible connections to the historical events and narratives represented in the NFT-based artworks. The craftsmanship and attention to detail applied in their creation further enhance their allure and intrinsic value. One significant advantage of the invention lies in the collateralization potential of the physical artifacts. The intrinsic value and historical significance of these artifacts provide a solid basis for their appraisal and assessment, further reinforcing the financial worth of the associated NFTs. This collateralization opens opportunities for art collectors to leverage the historical and artistic value of the Ethistorial Artworks for obtaining loans or engaging in other financial arrangements with financial institutions. To protect the historical and artistic value of the Ethistorial Artworks, the invention incorporates intellectual property protection mechanisms. By registering and protecting the NFT-based artworks with intellectual property rights, the creators and owners ensure their legal recognition, authenticity, and commercial viability. This fosters an environment conducive to artistic innovation and preservation while safeguarding the rights and interests of the stakeholders involved. Furthermore, the invention facilitates immersive experiences and public engagement with the Ethistorial Artworks. Artistic performances, events, and exhibitions provide platforms for individuals to interact with the historical narratives and cultural significance embedded within the artworks. This experiential dimension deepens the appreciation for history, stimulates dialogue, and fosters collective understanding. In summary, the present invention offers a comprehensive and innovative method for creating, monetizing, and collateralizing historical events through the integration of NFT-based artworks, physical objects, and advanced technologies within the Ethistorial Art genre. By bridging the virtual and physical realms, this invention revolutionizes the contemporary art market, providing new avenues for artistic expression, financial opportunities, and cultural enrichment.

This application introduces the very first Ethistorial Artworks based on one ugly history happened in 1989. In 1989, a profound theft shook the House of Saud, leading to conspiracy, death, and distrust. The Blue Diamond Affair, a tragic saga spanning years, brought about the demise of three Saudi diplomats and incarcerated the thief who dared to challenge the boundaries of trust. Apart from the betrayal of trust between the thief and their master, many Saudi Arabians home and abroad had their livelihoods compromised or threatened. As the years went by, political ties between nations were severed, turning the lives of hundreds of thousands of Thais in Saudi Arabia upside down. More than three decades of later, the diamonds and jewels of Saudi Arabia remain unrecovered. The Kingdom of Saudi Arabia, known as The Land of Sand has amassed great wealth from its petroleum sources, earning its place as the world's energy reserve and a seat of power. Their leadership in Middle East and North Africa echoes through the globe as a nation of strength and prosperity. Saudi Arabia however, does not have everything. Across the continents in the Kingdom of Thailand, or the Land of Smiles, the world's food is grown and life thrives and perseveres. Its comforts of sustenance and natural beauty creates a much treasured symbiosis between the two kingdoms. Without life, power holds no meaning. And without power, life fails to find direction.

Name of the artwork is the “Sand dust in the wind” is now commemorating the Blue Diamond Affair Through the Ethistorial Artworks. Incepting the balance of power with the sustenance of life, Ethistorical Artist elects Thailand's national fruit, the mangosteen, as the concluding actor in The Blue Diamond Affair, and the beginning of a new saga, The Sand dust in the wind. Deep in the lush, tropical land of Thailand, exists a fruit like no other—the mighty mangosteen, also known as the queen of fruits. With its rich cultural and historical significance to the Thai people, for over two centuries, these rare and precious fruits have been heralded as the queen of fruits, a title bestowed upon them by none other than British Queen Victoria. Intrigued by these exotic fruits once given as a gift, she tasted one and was immediately enamored by their sweet, juicy flesh and delicate flavor. She declared them to be the finest fruit she had ever tasted, and promptly bestowed upon them the regal title they bear to this day. But despite its importance, the fruit is in danger of disappearing from the world, just as the blue diamonds did. Mangosteen trees are at risk of being replaced by more lucrative cash crops, leaving only a handful of trees left to lay claim to being the true heirs to the title of “Queen of Fruits”. Immortalizing the history of the Blue Diamond Affair and legacy of the Queen of Fruits, our artist sought the mangosteen for its embodiment of vitality and compromise to rebuild the bridge between two nations. The sand dust in the wind is the commemoration and conclusion of the Blue Diamond Affair as a collection of NFTs representing 200 unique digital and physical art counterparts. Each token will be redeemable for a bespoke piece of jewelry containing in its core the most fruitful seed of the oldest Mangosteen tree of 200 years.

The NFT: By owning the sand dust in the wind NFT, collectors gains access to a holographic viewing of the digital artwork associated with their token. Each digital artwork represents an aspect of the sand dust in the wind saga including scenes of events or artistic interpretation of The Blue Diamond Affair. This immersive experience allows individuals to explore the intricate details and symbolism of the artwork, bringing it to life in a mesmerizing display of colors, textures, and narratives. Through the NFT experience, viewers can delve deeper into the layers of meaning behind each piece, fostering a greater appreciation for the historical context and artistic craftsmanship.

1. A method for creating a new genre of the contemporary arts which is named as the Ethistorial Art, comprising converting historical incidents and events into captivating artworks represented by Non-Fungible Tokens (NFTs).

2. The method according to claim 1, further incorporating decentralized blockchain technology to ensure the secure and transparent representation of the NFT-based artworks.

3. The method according to claim 1, wherein high-end technologies, including electrical discharge machining (EDM), are employed to enhance the precision accuracy, quality, and artistic value of physical artifacts associated with the NFT-based artworks.

4. The method according to claim 1, wherein the physical artifacts, such as symbolic jewelry and tangible objects, serve as tangible connections to the historical events represented in the NFT-based artworks, further enhancing their aesthetic and intrinsic value.

5. A system for intellectual property protection within the realm of Ethistorial Art, involving the registration and protection of NFT-based artworks and their associated intellectual property rights to ensure legal recognition, authenticity, and commercial viability.

6. The system according to claim 5, wherein the registration and protection of NFT-based artworks encompass the preservation of historical narratives, artistic expression, and technological innovations, fostering an environment conducive to artistic innovation, preservation, and fair economic practices.

7. The method according to claim 1, further comprising the collateralization of physical artifacts based on their appraised value, reinforcing the financial worth and investment potential of the associated NFT-based artworks.

8. The method according to claim 7, wherein the collateralization of physical artifacts opens opportunities for art collectors to leverage their historical and artistic value for obtaining loans or engaging in other financial arrangements with financial institutions.

9. A method for promoting public engagement and immersive experiences with Ethistorial Artworks through artistic performances, events, and exhibitions, providing platforms for individuals to interact with the historical narratives and cultural significance embedded within the artworks.

10. The method according to claim 9, wherein the public engagement and immersive experiences enhance the appreciation for history, stimulate dialogue, and foster collective understanding, promoting cultural enrichment and preservation.

11. The method according to claim 1, wherein the integration of NFTs, historical narratives, physical artifacts, and advanced technologies establishes a new paradigm in the contemporary art market, offering new avenues for artistic expression, financial opportunities, and cultural exchange.
